(19) United States
(12) Patent Application Publication
(10) Pub. No.: US 2006/0168275 A1
(43) Pub. Date: Jul. 27, 2006

(54) Method to facilitate a service convergence fabric

(76) Inventors: Peter A. Lin, Lisle, IL (US); Patrick M. Maurer, Wayland, MA (US); Patrick D. Smith, Deerfield, IL (US); Narayanan Venkitaraman, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/272,396

(22) Filed: Nov. 10, 2005

Related U.S. Application Data
(60) Provisional application No. 60/630,106, filed on Nov. 22, 2004.

(51) Int. Cl. G06F 15/16

(52) U.S. Cl. 709/230

(57) ABSTRACT

A service convergence fabric (51) is provided (11) between a plurality of independent access networks, control networks, and services networks (56) and a converged application layer (50). The service convergence fabric has access (12) to information regarding at least one of end-user information, service information, network information, device information, resource information, application information, and edge gateway information. The service convergence fabric uses (13) such information to facilitate interaction between applications of the converged application layer and one or more networks of the plurality of networks.

### TECHNICAL FIELD

This invention relates generally to the effectuation of applications via independent networks.

### BACKGROUND

Networks of various kinds are known in the art. These include, as illustrative examples, access networks, control networks, and services networks (with those skilled in the art recognizing that any given network may serve as one or more of these network types, such that a given network may comprise, for example, both an access and control network). In some cases, a limited aspect of integration may apply across two or more such networks. More typically, however, such networks operate independently of one another to a greater or lesser extent. (As used herein, “independent” can refer to technological independence (as when two networks are operationally incompatible with one another), access independence (as when two networks are unable to access one another due to lack of, for example, a facilitating connection therebetween), and/or operational independence (as when two networks are separately administered in a manner that wholly or partially precludes transparent interaction therebetween).)

As a result, a typical modern user of technology finds themselves surrounded in their day-to-day lives with a vast number of differing services and/or end-user devices that, in many cases, operate utterly independently of one another. Of course, in cases where the end-user devices are effecting utterly distinct services for the end user, such differentiation presently poses little concern from a prior art perspective. For example, little concern presently exists when noting that wireless telephones provide two-way voice telephone service and televisions provide for reception of television broadcasts; i.e., a lack of integration between such networks does not necessarily equate with a problem when viewed from a prior art perspective.

The depth of this lack of concern becomes particularly evident when considering that, in some cases, some existing network integration does not invite more aggressive leveraging of the potential represented by such integration. For example, cable service providers now often provide both telephony services and television reception services via an integrated network. For the most part, however, in many cases this integration relates more to the mode of transport rather than to an integration of the services offered via that integrated network.

These conditions exist, in large part, due to a different problem; the existence of a myriad number and type of applications that presently typify the prior art. Applications comprise the vehicles by which various services and actions are ultimately effected on behalf of a given end-user (or other network element or node). To put it another way, networks provide the conduit by which an application-based service reaches a given end-user. For example, a telephony application is what permits telephony service to reach a given end-user via a given network.

At present, more often than not, a given application requires considerable native intelligence and vertical awareness in order to work successfully in or with a given network. This situation reflects, of course, the simple fact that most networks, one way or the other, are independent from one another, thus largely frustrating any intent to extend the reach of a given application across multiple networks. There are instances where a given application operates over multiple networks, but again, these instances typically reflect considerable effort by either the application designer or the network designer to accommodate such operability. Such highly customized solutions, while useful in a given instance, have done little to drive a greater awareness of the possibilities.

### BRIEF DESCRIPTION OF THE DRAWINGS

The above needs are at least partially met through provision of the method to facilitate a service convergence fabric as set forth in the following detailed description, particularly when studied in conjunction with the drawings, wherein:

FIG. 1 comprises a flow diagram as configured in accordance with various embodiments of the invention;

FIG. 2 comprises a schematic depiction as configured in accordance with various embodiments of the invention;

FIG. 3 comprises a flow diagram as configured in accordance with various embodiments of the invention;

FIG. 4 comprises a flow diagram as configured in accordance with various embodiments of the invention; and

FIG. 5 comprises a schematic depiction as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, a service convergence fabric, interposed between a plurality of independent access networks, control networks, and service networks on the one hand, and a converged application layer on the other facilitates a considerable degree of desired capability. Properly configured and deployed, such a service convergence fabric can be used as an application server with respect to the plurality of access networks and control networks and as a control server or application gateway with respect to the plurality of services networks. Viewed in a different aspect, to preserve a capability of operation with legacy networks, the service convergence fabric preferably interacts with services networks in a manner consistent with that of the behavior of access or control networks, while also interacting with access or control networks in a manner consistent with that of the behavior of services networks. In a preferred approach, the service convergence fabric has access to information regarding at least one of end-user information, service information, network information, device information, resource information, application information, and/or edge gateway information.

Pursuant to a preferred approach, this informational access permits and facilitates obtainment by the service convergence fabric of contextual information regarding at least one entity in the plurality of networks and the obtainment of other information (including particularly triggering information) as corresponds to at least a first entity as is associated with at least one of those networks. The latter information is then processed within the service convergence fabric with respect to the contextual information to form processed information, which processed information is then distributed to at least one entity as is associated with one or more of the plurality of networks.

As will be shown in more detail below, such a configuration permits use of the service convergence fabric to effect service fusion. In a preferred embodiment, this fusion is effected by the service convergence fabric at least partially in an automatic and transparent manner with respect to a given application of a converged application layer such that the given application can be facilitated via dynamic selection and use from amongst a plurality of candidate networks. This, in turn, permits a degree of leveraging with respect to network resources to a previously unavailable degree. The end user experience becomes considerably more transparent and intuitive as a given application becomes able to effect delivery of a given service via a plurality of otherwise independent networks.

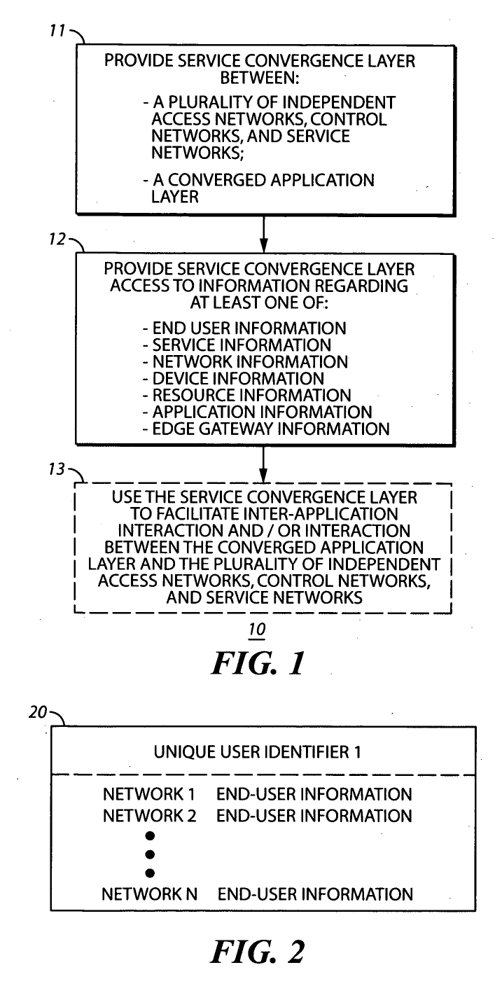

These and other benefits may become more evident upon making a thorough review and study of the following detailed description. Referring now to the drawings, and in particular to FIG. 1, a process 10 in correspondence with these teachings provides 11 a service convergence fabric between, on the one hand, a plurality of independent access networks, control networks, and service networks, and on the other hand, a converged application layer. The converged application layer essentially comprises all available applications (including but not limited to applications that are used by an end-user device and/or that serve to effect some desired interaction or use of an end-user device). These applications will preferably include both legacy applications and later-developed applications, where the latter may hopefully be typified by an innate awareness of the service convergence fabric and its capabilities as described below (whereas legacy applications are more likely to be specifically unaware of the service convergence fabric or its capabilities).

This service convergence fabric couples in any appropriate fashion to these various applications of the converged application layer. As per one approach, the service convergence fabric comprises at least one (and likely a plurality of) Application Programming Interfaces (APIs) for this purpose (including as illustrative examples, but not limited to, Parlay and JAIN Application Programming Interfaces as are known in the art). Such Application Programming Interfaces can readily serve, in a manner otherwise understood in the art, to interface the service convergence fabric with the applications of the converged application layer.

In many cases, and particularly when dealing with legacy applications, there may be a one-to-one relationship between the application and a given Application Programming Interface. Such correspondence will often be appropriate in order to assure a compatible interaction between the API and the corresponding application. In other cases, one Application Programming Interface may support compatible interaction with more than one application. Such may particularly be expected when application designers are aware and cognizant of one or more particularly useful Application Programming Interfaces as may comprise a part of the service convergence fabric.

This preferred process 10 then provides 12 access by the service convergence fabric to information. More particularly, the service convergence fabric has access to information regarding one or more of:
end-user information comprising, for example, information regarding at least one of an information consumer and/or an end-user device (including information such as, but not limited to, end-user name, address, present geographic or network location, activities (such as active sessions or devices associated with the end user), preferences (including, for example, operating preferences of the information consumer), contact lists (such as associations with other end users), history (such as information regarding past behaviors, bookmarks, and so forth), end-user device operational status, presently available end-user devices, functional capabilities of an end-user device, present and/or anticipated availability of the end user, priorities of the end user in the case of contention issues, and so forth);
service information (where “service” is understood to comprise one or more applications as are provided to an end user or device via other devices, such that the application itself does not reside entirely within a device) (such as, but not limited to, services subscribed to by the end user, access and/or other administrative rights, service types and features, usage limits, quality of service rights or priorities/preferences, other information regarding at least two of the plurality of aforementioned networks (such as, to illustrate, information corresponding to at least one of presently allocated communication resources, presently available allocable communication resources, an end user's subscription rights, and an end user's application rights on each access network, to name a few), and so forth);
network information (such as, but not limited to, access type (such as Code Division Multiple Access (CDMA), Wireless Local Area Network (WLAN), cable, and so forth), accessibility, billing and accounting information, and so forth);
device information (such as, but not limited to, device names, identifiers (such as a MAC address, IP address, Serial Number, model number, manufacturer's identity, version and/or release number, and so forth), capabilities (access method, display type or resolution, power limitations, associated service(s), and so forth), state (such as active, standby, off, and the like), available applications, and so forth);
resource information (such as, but not limited to, addresses of available content, available (or accessible) bandwidth, quality of service capability, signal strength, current link conditions, current network loading, an available point of display and/or audibilization, transcoding or format conversion capabilities, and so forth);
application information (such as, but not limited to, application types, utilized and/or available formats, translation capability, enablement and/or administrative requirements, and so forth); and
edge gateway information (such as, but not limited to, administrative privileges and/or ownership, adjacent devices, subtending, throughput capabilities, and so forth as pertain to an edge gateway (wherein an “edge gateway” is understood to comprise, for example, an access point such as an 802.11-family or Bluetooth-family compliant wireless access point, a Network Interface Device (NID), a set-top box, or the like)).

Access to such information can be realized in any of a wide variety of ways. For example, such information can be fully stored and contained within the service convergence fabric or can be partially or wholly stored external to the service convergence fabric as will be readily understood by those skilled in the art.

When storing such information, in a preferred embodiment at least the end-user information is stored in correlation with a unique user identifier. To illustrate, and with momentary reference to FIG. 2, all of the information as corresponds to a particular end user (such as a particular information consumer) can be stored 20 in conjunction with a corresponding unique user identifier. This unique user identifier will preferably correlate to a plurality of end-user devices and independent access networks, control networks, and services networks to the extent that such devices and networks correspond to a particular information consumer. Therefore, as illustrated, “Network 1 End-User Information” can correlate to information regarding both a first network and such end-user device (or devices) as this particular information consumer has that operates compatibly with that first network.

As one simple example, when the first network comprises a particular broadband television service provider, then the network information for a given information consumer can comprise information regarding the network itself (such as allocable channels, content sources, coverage, roaming and/or sharing agreements, and so forth), information regarding the information consumer's relationship with that network (such as, but not limited to, account and billing information, content access permissions, quality of service, and so forth), and information regarding the information consumer's end-user devices (such as the identity, specific location, and present and/or scheduled operational status) that the information consumer uses to compatibly interface with this network.

In the illustrative examples provided above, this unique identifier correlates one-for-one with a single individual information consumer. It would also be possible, however, to provide a unique identifier that correlates to a plurality of individual information consumers. For example, a push-to-talk talk group or a buddy list or other established group may be identified with a single unique identifier that then serves to further correlate to the same kinds of information elements and nodes for each of such a group of information consumers as is otherwise set forth above.

In general, and referring again to FIG. 1, it is preferred that such information be collected in an on-going manner. For example, when a given node first becomes operational, or experiences some predetermined level of change with respect to a past state or condition, that node can be configured to automatically provide such information to the service convergence fabric (or to some surrogate or proxy as may be desired by the node or system designer).

As another example, the service convergence fabric (or, again, some surrogate or proxy acting on its behalf) can originate a request for such information in response to one or more predetermined triggers. Such triggers can be many and varied, and can include, for example, detection of a new node and/or detection of an altered state for an existing node, a passage of some predetermined duration of time, detection of a request for provision of a particular service and/or application, and so forth.

So configured, the service convergence fabric is suitably positioned and provisioned in a manner that permits the uses and purposes set forth herein. In particular, the service convergence fabric is now available for use 13 to facilitate inter-application interaction and/or interaction between the converged application layer and the plurality of independent access networks, control networks, and service networks. This can comprise, for example, the service convergence fabric being used as an application server with respect to the plurality of independent access networks and control networks and as an application gateway with respect to the plurality of services networks. More particularly, a service convergence fabric so deployed and provisioned can be used to at least partially automatically and transparently effect service fusion with respect to a given application of the converged application layer such that the given application is facilitated via dynamic selection and use from amongst a plurality of candidate ones of the plurality of independent access networks, control networks, and services networks. As an example, the service convergence fabric may facilitate service fusion by supporting features common to converged applications. These include, but are not limited to, tracking the user identity, state, and/or profile, device identity, state, and/or profile, session state, and/or location as may be present in different forms in one or a plurality of networks, servers, or devices.

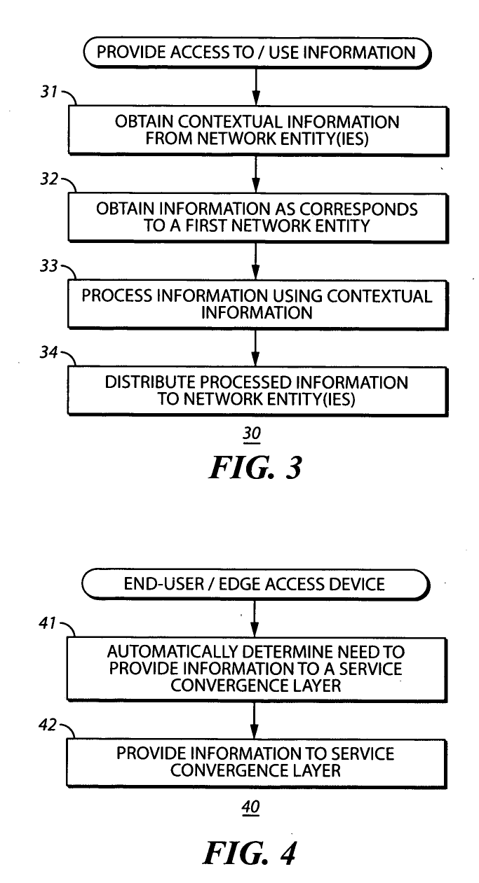

To illustrate, and referring now to FIG. 3, this provision of information to a service convergence fabric can more specifically comprise a process 30 wherein the service convergence fabric obtains 31 contextual information from at least one entity from amongst a plurality of independent access networks, control networks, and services networks (and more preferably from a plurality of, or even all, entities as comprise a part of such networks). This entity can comprise, for example, a network server, an edge gateway, a client device, or an application server, to name a few. (Those skilled in the art will recognize that an application server, in turn, may encompass at least certain types of servers in the domain of certain service providers (for example, those who own, operate, and/or sell multiple applications to an access network).) Such contextual information comprises, at the least, a sense of a present and/or future context for such networks and their served constituents and more specifically will preferably comprise state information (such as, for example, time, operating mode, and so forth and may also include, for example, profile information containing preferences and the like) as relates to a given user.

This process 30 then further provides for the obtainment 32 of information as corresponds to a least a first entity as is associated with at least one of the plurality of independent access networks, control networks, and/or services networks. The service convergence fabric then processes 33 that latter information using the contextual information to thereby form processed information, which the service convergence fabric then distributes 34 to the at least one entity. Those skilled in the art will recognize that such distribution can include, but is not limited to, the origination of messages that are directed to an entity in a relevant one (or more) of the access, control, or services networks based on, for example, requests for a corresponding application (or applications). Those skilled in the art will also recognize that such distribution need not be immediate; rather, the processed information may be stored, or the unprocessed information stored and the processing delayed, until an appropriate time for distribution presents itself.

As one illustrative example, the service convergence fabric can gather contextual information regarding a particular information consumer that includes information regarding their broadband wide area network status and their broadband cable television service. This contextual information can then be used to effect, for example, automatically shifting receipt of an incoming video stream from a first end-user device (as operates with the broadband wide area network) to a second end-user device (as operates with the broadband cable television service).

This shift may encompass not only identifying the opportunity and the enabling platforms and networks, but also the processing of the delivered content to ensure its compatible and useful reception and presentation. For example, a very different format for the video content may be used when delivering the content to the information consumer via a first network/end-user device as compared to a second network/end-user device. In a preferred approach, the service convergence fabric facilitates such processing in order to aid in a transparent delivery of the desired content to the information consumer.

Another example of the service convergence fabric usage is to automatically add a video streaming session to a current voice conversation between two parties when the service convergence fabric detects or otherwise responds to the availability of broadband connectivity for both users and such service otherwise fits the service profiles of the users.

Although the service convergence fabric can effect many, or even all, of these processes (and thereby achieve their attendant benefits) in a substantially transparent fashion, there are benefits to accrue by imbuing at least some external elements with an awareness of the service convergence fabric, or at least an ability to interact with a surrogate or proxy of the service convergence fabric. For example, and referring now to FIG. 4, and end-user device or an edge access device will preferably implement a process 40 whereby the device automatically determines 41 a need to provide information to a service convergence fabric (again, this information can comprise, though is not limited to, information regarding an end-user device, an edge access device, an information consumer, and so forth).

Recognition of this need can be triggered or based upon any of a wide variety of inputs or circumstances. For example, this determination can be based upon ascertaining a present unregistered status of the device with respect to a service convergence fabric (as may occur, for example, when a new device (or an existing device) first powers up, first registers with a new network or service, and so forth). As another example, this determination can be based upon receiving a request for the information (as may occur, for example, when the service convergence fabric (or a surrogate or proxy operating on behalf of the service convergence fabric) sources such a request based upon, for example, determining that the device exists but that current information regarding that device is not presently available to the service convergence fabric). Other illustrative triggers include, but are not limited to, initiation, receipt, or routing of a call control message, such as an INVITE message, a message comprising an update or change with respect to presence information, location information, or the like, a change with respect to available or allocated bandwidth, network connectivity, signal strength, current link conditions, current network loading, or the like, and so forth. The start, end, or change of a data stream and/or session could also comprise a trigger.

Provision of the information to the service convergence fabric can be realized through any number of supportive processes. As one example, the device can simply transmit a message, specifically addressed to the service convergence fabric, that contains the information. This approach, of course, tends to benefit from awareness on the part of the device as to the existence of the service convergence fabric.

As another example, the device can transmit such a message to a node (such as a node within the network within which the device operates including, but not limited to, any of a wide variety of lower layer access and/or session control entities and higher layer service network and/or application layer entities) that themselves act as a surrogate or proxy for the service convergence fabric. Using this approach, the device does not necessarily require a priori knowledge regarding the existence of the service convergence fabric as the intervening node can effect the provision of the information to the service convergence fabric. Examples of such nodes include, but are not limited to, Residential Gateways, Wireless LAN Access Points, Network Interface Devices (NIDs), and Cable Set-top boxes, to name a few. Those skilled in the art will also recognize that at least some such information might also be manually entered by, for example, the information consumer themselves, a network administrator, an application administrator, or the like.

It is also possible that information as used by the service convergence fabric to inform its service fusion functionality can be obtained, at least in part, via more indirect methods. This may be useful in situations where a given network administrator may be otherwise reluctant, for whatever reason, to share certain data regarding their network and/or its subscriber base. For example, when a wireless service provider does not have an information sharing agreement with a cable network operator. The Service Convergence Fabric in this case collects the information from the device directly and uses the information to effect the described fusion of the services.

For example, a given end user may initiate a phone call using a cell phone end-user device. That cell phone might be registered with a network cell site that is located remotely with respect to a home of office for that particular end user. The service convergence fabric can therefore ascertain that this particular end user is not presently at their home or at their office and could update information regarding that user's present state accordingly.

As another example, an end-user device can obtain an Internet Protocol address from a wireless local area network access point. The end-user device can itself capture both this address and the Internet Protocol address of the corresponding gateway and forward that information to the service convergence fabric.

As yet another example, an end-user device, upon sensing an open wireless local area network access point, can simply capture any available characterizing information (such as any advertised Internet Protocol addresses) and forward that information on to the service convergence fabric. The latter, in turn, can then use such information to inform, for example, handoff decision making functionality.

As yet one more example, an end-user device can capture information from and/or regarding other devices as may be subtending an edge device. Such information can then, again, be forwarded on to the service convergence fabric for subsequent use thereby.

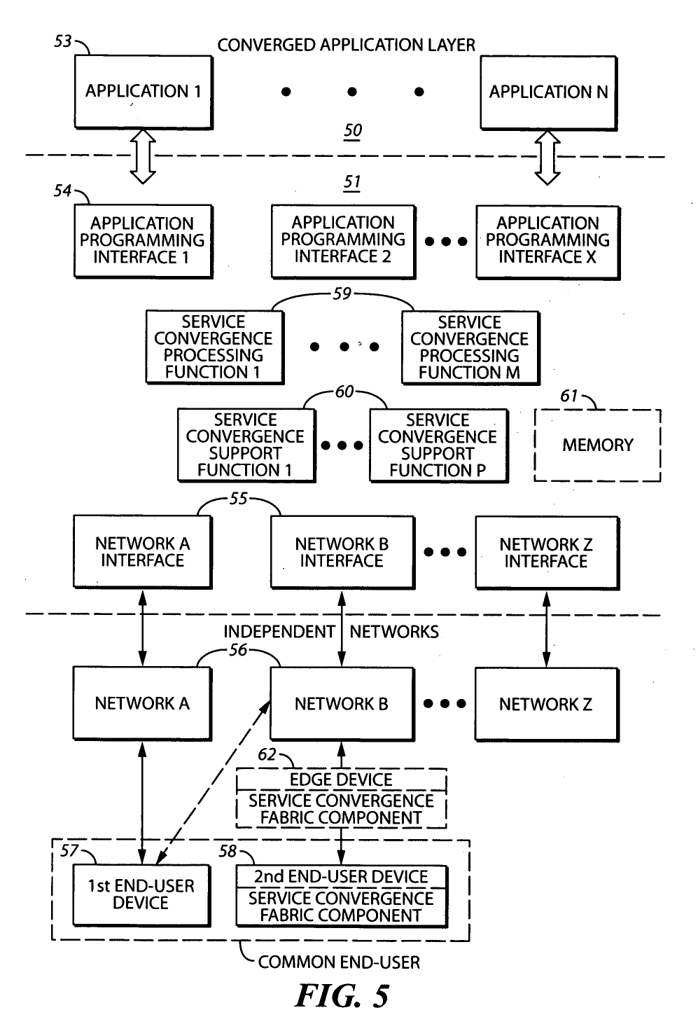

Referring now to FIG. 5, those skilled in the art will now appreciate that any number of applications (such as, for example, an application 1 53) as comprise a converged application layer 50 can interface with a service convergence fabric 51 via an appropriate corresponding Application Programming Interface (such as, for example, Application Programming Interface 1 54). Those skilled in the art will appreciate and understand that such Application Programming Interfaces can be deployed via a single platform or can be distributed as broadly, or narrowly, as may best suit the needs, requirements, and resources of a given setting.

Similarly, the service convergence fabric 51 comprises a plurality of network interfaces 55 wherein each such network interface typically effects a compatible interaction with one (or, less typically, more than one) corresponding network 56 (which network may comprise an access network, a control network, and/or a services network as described above). To interact with resources in each network provider domain, the service convergence fabric can rely on access-network specific protocols such as Session Initiation Protocol or OSA/Parlay. For instance, in the case of IMS, the service convergence fabric could rely on the ISC interface as is based on Session Initiation Protocol.

The service convergence fabric 51 itself can comprise a layer having an engine to effect the teachings set forth herein. More specifically, this engine permits the service convergence fabric 51 to obtain information as described above and to use that information to effect the processing of content as is being directed to an end user and/or to otherwise effect and select the routing of such content via the various networks as may be available for such service in a given instance. Those skilled in the art will appreciate that this engine can comprise, if desired, a single dedicated platform but can also comprise, perhaps more typically, a distributed process that includes a large number of supporting platforms. Generally speaking, such a service convergence fabric 51 will comprise a plurality of service convergence processing functions 59 and a plurality of service convergence support functions 60. The service convergence fabric 51 will also optionally, but preferably, comprise at least some memory 61 to facilitate at least temporary retention of the information referred to herein.

Such supporting platforms can themselves either be dedicated to the functionality of the service convergence fabric 51 or can also serve other purposes as well. Such architectural and deployment options and choices are generally well understood by those skilled in the art and hence require no further elaboration here.

More particularly, the service convergence fabric itself preferably consists of some or all of the following functional components:

Convergence Coordination Function: This function preferably provides convergence of at least one of the following: user identities, device, access and service ownership, session control, and resource capabilities. The Convergence Coordination Function comprises the logical entity performing, among other features, processing of contextual and other information to effect service fusion. It takes input from service provider and operator databases, manually entered profile information, and/or from corresponding network, edge, and/or end user support functions. This information is then accessed by various applications via Application Programming Interfaces. Based on requests from applications, the Convergence Coordination Function also performs functions such as resource allocation and/or de-allocation, session initiation, modification, and/or termination. This may involve interacting with support functions in a core network, access network, edge network, or end-user device, or with legacy interfaces via an appropriate legacy-technology-specific protocol (or protocols). These functions may be performed directly by a Convergence Coordination Function device or platform or indirectly by way of a redirect function. The Convergence Coordination Function may also perform actions in response to requests by one or a plurality of the network support function, the edge support function, or the client support function.

Network Support Function: This function interfaces to the session control network, and possibly to edge infrastructure devices and/or client devices. It also interfaces to the Convergence Coordination Function. It provides session, access, and rights information to the coordination function. Some of this information may not be available to edge or end-user devices. The network support function may also perform actions in response to commands by the Convergence Coordination Function.

Edge Support Function: This function interfaces to the access networks and to client devices. It may reside in a device under the administrative control of an end user. It also interfaces to the Convergence Coordination Function. It provides session, resource, and identity information about itself and devices subtending it to the coordination function. The edge support function may also perform actions in response to commands by the Convergence Coordination Function.

Client Support Function: This function interfaces to applications and resources residing in the client devices. These resources may include network access, control resources, format alteration or content transcoding, media resources such as human interface (input or output) capabilities, or other resources. The client support function provides this information about itself to the Convergence Coordination Function. The client support function may also perform actions in response to commands by the Convergence Coordination Function.

So configured and deployed, the service convergence fabric 51, via, for example, Application Programming Interface 1 54, can receive content and/or deliver capabilities from application 1 54 to an ultimate information consumer via either of a first end-user device 57 and a second end-user device 58. This activity can occur upon initial delivery of the application service and/or during the course of such delivery. The service convergence fabric 51 can effect delivery of the application capability to a given end-user in a manner that may best suit present circumstances and by otherwise taking into account a context that is most relevant to that particular end-user or setting.

It will be understood by those skilled in the art that these same benefits and capabilities are achieved regardless of whether the end-user devices are without any sense of the service convergence fabric 51 or, in fact, themselves comprise some service convergence fabric component (as suggested in FIG. 5 for the second end-user device 58). Similarly, these teachings are wholly applicable regardless of whether each end-user device is compatible with only a single network or, as optionally indicated in FIG. 5 for the first end-user device 57, the end-user device is capable of compatible operation with a plurality of independent networks. Also, those skilled in the art will appreciate that these teachings are also fully deployable regardless of whether an edge device 62 is juxtaposed (or comprises a part of) a given network and a given end-user device (and regardless of whether that edge device is sans knowledge of the service convergence fabric 51 or comprises its own service convergence fabric component).

The described service convergence fabric is therefore seen to provide a converged service function that enables application developers to create services that operate transparently over multiple access networks. To enable this, this functionality preferably supports features common to converged applications. These include tracking the user identity, state and profile, device identity, state and profile, session state, and location (to name a few) across multiple networks. At a minimum, information gathered about users and their sessions, resources, and access are preferably exposed using a simple Application Programming Interface that can be used by converged service developers. This richer convergence function should aid in resolving conflicting resource requests, to prioritize services based on profile and state information, to free applications from some of the burden of coordination, and to allow legacy applications to migrate to other access networks and devices.

An illustrative but preferred approach is therefore seen to promote and/or facilitate:

interaction with call control functions and service resources in all the networks that form part of the (virtual) converged network;

management of identities, sessions, state, and preferences common to multiple applications on a per-user basis;

provision of an open interface for application developers to implement the service logic; and

communication with end-user devices and other entities in each network using the network's native protocols.

The combination of these functions results in a framework for seamless, user-centric service migration across networks and devices. This can include and permit, for example, having a converged service rely, at least in part, on cooperative operation and interworking of a plurality of core networks, wherein at least some of the core networks are in dissimilar domains with respect to one another. The described converged services fabric effectively provides a means of coordinating identities, sessions, services, and network and device resources with applications. As implied by the word “fabric,” such converged services support can be centralized and/or distributed over a plurality of enabling platforms.

These teachings comprise an effective mechanism for coordinating services across a plurality of disparate call servers. While prior art approaches facilitate roaming from one network to another, these teachings permit making a given service/application available across those networks, thus greatly contributing to improving the experience of the information consumer. These benefits accrue in part due to the native ability of the service convergence fabric to collect, manage, and provide state information (such as information regarding active sessions, devices present in a given session, device capabilities, network availability, user preferences, application resources, and so forth) for use in applications that serve end users. The service convergence fabric effectively facilitates substantially seamless service delivery by managing multiple identifies, profiles, sessions, and resources as are available to a given user across multiple independent networks.

These teachings also permit compatible use with existing elements that are not designed with native awareness of the service convergence fabric. To legacy elements, the service convergence fabric comprises a substantially opaque middle fabric that effectively decouples services/applications from networks of various kinds. This, in turns, aids in facilitating backward compatibility. On the other hand, elements designed with awareness of the service convergence fabric can effectively interact with this fabric as a service, thereby effecting provision of more transparent services/applications to end users.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for use with a plurality of independent access networks, control networks, and services networks comprising:
providing a service convergence fabric between the plurality of independent access networks, control networks, and services networks and a converged application layer;
providing access by the service convergence fabric to information regarding at least one of:
end-user information;
service information;
network information;
device information;
resource information;
application information;
edge gateway information.

2. The method of claim 1 wherein the service convergence fabric is a distributed process having a plurality of supporting platforms.

3. The method of claim 1 wherein the service convergence fabric is a single dedicated platform.

4. The method of claim 1 wherein providing access by the service convergence fabric to information further comprises:
obtaining contextual information from at least one entity in the plurality of independent access networks, control networks, and services networks;
obtaining information that corresponds to at least a first entity as is associated with at least one of the plurality of independent access networks, control networks, and services networks;
processing the information using the contextual information to form processed information;
distributing the processed information to at least one entity as is associated with at least one of the plurality of independent access networks, control networks, and services networks.

5. The method of claim 4, wherein each of the entities comprise at least one of:
a network server,
an edge gateway;
a client device;
an application server.

6. The method of claim 1 wherein providing a service convergence fabric further comprises providing at least one Application Programming Interface (API).

7. The method of claim 6 wherein providing at least one API further comprises using the API to interface with the converged application layer.

8. The method of claim 7 wherein:
providing at least one API further comprises providing a plurality of API's;
using the API to interface with the converged application layer further comprises using the plurality of API's to interface with the converged application layer.

9. The method of claim 1 wherein providing access by the service convergence fabric to information further comprises originating a request for the information.

10. The method of claim 9 wherein originating a request for the information further comprises transmitting the request to at least one of:
an end-user;
an Access Network;
an edge access device;
an application.

11. The method of claim 1 wherein providing access by the service convergence fabric to information further comprises receiving the information.

12. The method of claim 11 wherein receiving the information further comprises receiving the information from a communication as pertains to at least one of:
an end-user;
an Access Network;
an edge access device;
a service;
an application.

13. The method of claim 1 and further comprising:
using the service convergence fabric as an application server with respect to the plurality of independent access networks and control networks;
using the service convergence fabric as an application gateway with respect to the services networks.

14. The method of claim 1 and further comprising:
using the service convergence fabric to at least partially automatically and transparently effect service fusion with respect to a given application of the converged application layer such that the given application is facilitated via dynamic selection and use from amongst a plurality of candidate ones of the plurality of independent access networks, control networks, and services networks.

15. The method of claim 14 wherein using the service convergence fabric further comprises:
having a converged service rely, at least in part, on cooperative operation and interworking of a plurality of core networks, wherein at least some of the core networks are in dissimilar domains with respect to one another.

16. The method of claim 1 wherein the end-user information comprises information regarding at least one of:
an information consumer;
an end-user device.

17. The method of claim 14 wherein the end-user information further comprises information regarding at least one of:
end-user device operational status;
identifying information as corresponds to the end-user device;
geographic location;
a reachable identifier;
presently available end-user devices;
functional capabilities of the end-user device;
operating preferences of the information consumer;
availability of the end user;
priorities of the end user in case of contention.

18. The method of claim 16 wherein the end-user information is stored in correlation to a unique user identifier, wherein the unique user identifier can correlate to a plurality of end-user devices and independent access networks, control networks, and services networks.

19. The method of claim 1 wherein the service information comprises information regarding at least two of the plurality of independent access networks, control networks, and services networks.

20. The method of claim 19 wherein the information regarding at least two of the plurality of independent access networks, control networks, and services networks further comprises information corresponding to at least one of:
presently allocated communication resources;
presently available allocable communication resources;
an end user's subscription rights;
an end user's application rights on each access network.

21. A method for use with at least one of an end-user device and an edge access device capable of facilitating an application and of compatible interaction with at least one of a group comprising access networks, control networks, and services networks, comprising:
automatically determining a need to provide information to a service convergence fabric that is interposed between a plurality of independent access networks, control networks, and services networks and a converged application layer;
providing the information to the service convergence fabric.

22. The method of claim 21 wherein automatically determining a need to provide information to a service convergence fabric further comprises automatically ascertaining a present unregistered status with respect to the service convergence fabric.

23. The method of claim 21 wherein automatically determining a need to provide information to a service convergence fabric further comprises receiving a request for the information from the service convergence fabric.

24. The method of claim 21 wherein the information corresponds to at least one of:
an information consumer;
an end-user device;
an edge access device.

25. The method of claim 24 wherein the end-user information further comprises information regarding at least one of:
identifying information as corresponds to the end-user device;
end-user device operational status;
geographic location;
reachablity information
functional capabilities of the end-user device;
operating preferences of the information consumer;
availability of the end user;
priorities of the user in case of contention.

26. A services convergence fabric that interfaces with a plurality of independent access networks, control networks, services networks and a converged application layer and is configured to have access to information regarding at least one of:
end-user information;
service information;
network information;
device information;
resource information;
application information;
edge gateway information.

27. The services convergence fabric of claim 26 further configured to
obtain contextual information from at least one entity in the plurality of independent access networks, control networks, and services networks;
obtain information that corresponds to at least a first entity as is associated with at least one of the plurality of independent access networks, control networks, and services networks;
process the information using the contextual information to form processed information;
distribute the processed information to at least one entity as is associated with at least one of the plurality of independent access networks, control networks, and services networks.
